(19) United States
(12) Patent Application Publication
(10) Pub. No.: US 2015/0132656 A1
(43) Pub. Date: May 14, 2015

(54) SLURRY COMPOSITION, ELECTRODE, ELECTRODE FOR NON-AQUEOUS ELECTROLYTE SECONDARY BATTERY, AND METHOD OF MANUFACTURING ELECTRODE FOR NON-AQUEOUS ELECTROLYTE SECONDARY BATTERY

(71) Applicant: TAIYO INK MFG. CO., LTD., Hiki-gun (JP)

(72) Inventor: Fumitaka KATO, Higashimatsuyama-shi (JP)

(73) Assignee: TAIYO INK MFG. CO., LTD., Hiki-gun (JP)

(21) Appl. No.: 14/539,477

(22) Filed: Nov. 12, 2014

(30) Foreign Application Priority Data
Nov. 12, 2013 (JP) 2013-234353
Oct. 7, 2014 (JP) 2014-206727

(51) Int. Cl. H01M 4/62; H01M 4/139; H01M 4/04

(52) U.S. Cl. CPC H01M 4/62; H01M 4/622; H01M 4/0404; H01M 4/139
USPC 429/233; 252/182.1; 252/500

(57) ABSTRACT

[Problem] Provided is a slurry composition which has an excellent viscosity stability and thus, after being applied to a current collector for an electrode and drying, has an excellent adhesion with the current collector.

[Solving Means] A slurry composition which is used for manufacturing an electrode for an electrochemical cell contains a lithium ion, comprising a polymer binder resin, an acid, and an active material.

### CROSS-REFERENCE TO RELATED APPLICATIONS

The present application claims the benefits of priority to Japanese Patent Application No. 2013-234353, filed Nov. 12, 2013, and Japanese Patent Application No. 2014-206727, filed Oct. 7, 2014. The entire contents of these applications are incorporated herein by reference.

### TECHNICAL FIELD

The present invention relates to a slurry composition, an electrode, an electrode for a non-aqueous electrolyte secondary battery and a method of manufacturing an electrode for a non-aqueous electrolyte secondary battery. Specifically, the present invention relates to a slurry composition having an excellent viscosity stability, an electrode using the slurry composition, an electrode for a non-aqueous electrolyte secondary battery using the electrode, and a method of manufacturing an electrode for a non-aqueous electrolyte secondary battery.

### BACKGROUND ART

In recent years, miniaturization and multi-functionality of electronic components are advanced, and many portable electronic devices have appeared. These devices are desired to be miniaturized and to have a reduced weight; and thus, batteries used for the power sources thereof are also desired to be miniaturized and to have a reduced weight. With backgrounds of environmental problems or resources problems, hybrid cars, electric cars and the like have been developed, and have started to be manufactured and sold. Also in such a so-called electric vehicle, utilization of an electric power source which is small and lightweight, which can be charged and discharged, and which has a high energy density is indispensable. As such an electric power source, a secondary battery such as a lithium ion battery or nickel hydrogen battery; an electric double layer capacitor; or the like is utilized. In particular, a non-aqueous electrolyte secondary battery such as a lithium ion secondary battery is attracting attention as an electric power source due to its high energy density or a high durability with which a battery can endure repeated charging and discharging, and development of such a battery is being made diligently.

A positive electrode of a lithium ion secondary battery comprises a composition containing an active material and a binder resin which binds the active material to a current collector, preferably a composition further containing a conductive assistant, a thickener, a surfactant, and the like which is formed on a metal foil as a current collector. A slurry of the composition is prepared by mixing the materials in water or an organic solvent, and the prepared composition in a state of slurry (hereinafter, referred to as a “slurry composition”) is applied to a current collector and dried, whereby a positive electrode is manufactured.

When a slurry composition is applied to a current collector, the viscosity of the slurry composition is important and the slurry composition needs to have a predetermined viscosity when applied. In cases in which a positive electrode of a lithium ion secondary battery is manufactured, after preparing a slurry composition, some time may be needed before the slurry composition is applied to a current collector. Accordingly, the slurry composition preferably maintains the same viscosity as that of the slurry composition immediately after it is prepared while storing, in other words, the slurry composition preferably has an excellent viscosity stability. However, in some cases, the viscosity of a conventional slurry composition had been gradually decreased after the slurry composition was prepared. When the viscosity of a slurry composition is lower than a predetermined viscosity, the adhesion of a slurry composition layer after the slurry composition is applied to a current collector and dried may be deteriorated. In particular, in cases in which a solvent which is used when a slurry is prepared is water, it has been highly probable that the viscosity of a slurry composition be deteriorated. The adhesion of a material of a positive electrode has an influence on the internal resistance or the like of a lithium ion secondary battery.

Examples of a slurry for manufacturing an electrode for a lithium ion-containing electrochemical cell include a slurry including a combination of at least three of polyacrylic acid (PAA), carboxymethyl cellulose (CMC), styrene-butadiene rubber (SBR) and polyvinylidene fluoride (PVDF) (Patent Document 1). Polyacrylic acid is used for lowering the pH of the slurry, which is considered to lead to avoid or inhibit corrosion. This is considered to be that, while an aluminum current collector may be corroded due to the alkalinity of the slurry, the corrosion is to be avoided by the use of a polyacrylic acid. A polyacrylic acid is thought to also have an effect of a thickener in the slurry.

### RELATED ART DOCUMENT

### Patent Document

Patent Document 1: Japanese Unexamined Patent Application Publication No. 2013-38074

### SUMMARY OF THE INVENTION

### Problems to be Solved by the Invention

However, although the viscosity of the slurry according to Patent Document 1 increases when the slurry is prepared due to the use of a polyacrylic acid, the viscosity stability has not been sufficient.

Accordingly, an object of the present invention is to provide: a slurry composition which has an excellent viscosity stability and thus, after being applied to a current collector for an electrode and drying, has an excellent adhesion with the current collector; an electrode which uses the slurry composition; an electrode for a non-aqueous electrolyte secondary battery which uses the electrode; and a method of manufacturing an electrode for a non-aqueous electrolyte secondary battery.

### Means for Solving the Problems

In order to solve the above-mentioned problems, the present inventor intensively studied to find that a slurry composition containing an acid, particularly an inorganic acid has an excellent viscosity stability and that an electrode obtained by applying the slurry composition to a current collector and drying has an excellent adhesion between a slurry composition layer and a current collecting plate, thereby completing the present invention.

A slurry composition of the present invention which is based on the above-mentioned findings is a slurry composition which is used for manufacturing an electrode for an electrochemical cell containing a lithium ion comprising a polymer binder resin, an acid, and an active material.

In the slurry composition of the present invention, the acid is preferably an inorganic acid, more preferably hexafluorophosphate. In addition, the slurry composition of the present invention preferably comprises a conductive assistant, and further contains at least any one of a thickener and a surfactant. Further, the slurry composition of the present invention preferably comprises a solvent, and particularly preferably contains water as a solvent.

The electrode of the present invention comprises the above-mentioned slurry composition is applied to a current collector.

The electrode for the non-aqueous electrolyte secondary battery of the present invention comprises the above-mentioned electrode.

A method of manufacturing the electrode for the non-aqueous electrolyte secondary battery of the present invention in which an active material and an acid are mixed, then a polymer binder resin is added thereto, and the mixture is further mixed to prepare a slurry composition and that the slurry composition is applied to a current collector.

### Effects of the Invention

According to the present invention, a slurry composition which has an excellent viscosity stability since the slurry composition contains an acid, particularly an inorganic acid is obtained, and thus an electrode having an excellent adhesion between a slurry composition layer and a current collector, and an electrode for a non-aqueous electrolyte secondary battery using the electrode are obtained.

### MODE FOR CARRYING OUT THE INVENTION

Embodiments of the present invention will be described in detail.

### <Slurry Composition>

The slurry composition of the present invention is a slurry composition which is used for manufacturing an electrode for an electrochemical cell containing a lithium ion, comprising at least a polymer binder resin, an acid, and an active material. By adding an acid to the slurry composition, the pH of a slurry composition is adjusted, thereby inhibiting deterioration of the viscosity. An electrode which uses a slurry composition of the present invention has an excellent adhesion between a slurry composition layer obtained by applying the slurry composition and by drying and a current collector. Further, a non-aqueous electrolyte secondary battery which uses the obtained electrode has a sufficiently low internal resistance, so that decrease in a discharge capacity over charge-discharge cycles can be inhibited even during repeated charging and discharging or under a high temperature environment due to heating, and thus, a long life secondary battery can be obtained. The components of the slurry composition of the present invention, and a method of manufacturing each of the components will be described in detail.

### <Active Material>

In a slurry composition of the present invention, a transition metal oxide, a transition metal sulfide, a lithium-containing complex metal oxide, and the like can be used as an active material for an electrode. Examples of the transition metal include Ti, V, Cr, Mn, Fe, Co, Ni, Cu, and Mo. As the transition metal oxide, for example, MnO, MnO₂, V₂O₅, V₆O₁₃, TiO₂, Cu₂V₂O₃, amorphous V₂O—P₂O₅, MoO₃, Li₄Ti₅O₁₂, and the like can be suitably used. Particularly from the viewpoint of the cycle stability and capacity, MnO, V₂O₅, V₆O₁₃, TiO₂, or Li₄Ti₅O₁₂ is suitable. As the transition metal sulfide, TiS₂, TiS₃, amorphous MoS₂, FeS and the like can be suitably used. The structure of the lithium-containing complex metal oxide is not particularly restricted, and one having a layer structure, a spinel structure, or an olivine structure or the like can be suitably used.

Examples of lithium-containing complex metal oxides having a layer structure include lithium-containing cobalt oxides (LiCoO₂), lithium-containing nickel oxides (LiNiO₂), lithium-containing complex metal oxides whose main structure is a Co—Ni—Mn complex metal oxide, lithium-containing complex metal oxides whose main structure is a Ni—Mn—Al complex metal oxide, and lithium-containing complex metal oxides whose main structure is a Ni—Co—Al complex metal oxide.

Examples of lithium-containing complex metal oxides having a spinel structure include lithium manganate (LiMn₂O₄), and Li[Mn_{3/2}M_{1/2}]O₄ (here, M is Cr, Fe, Co, Ni, Cu, or the like) in which a part of Mn is replaced with another transition metal.

Examples of lithium-containing complex metal oxides having a olivine structure include a olivine lithium phosphate compound represented by Li_{X}MPO₄ (in the formula, M is at least one selected from Mn, Fe, Co, Ni, Cu, Mg, Zn, V, Ca, Sr, Ba, Ti, Al, Si, B, and Mo, 0≦X≦2). Among the lithium-containing complex metal oxides, LiFePO₄ and LiCoPO₄ are often used by being pulverized since they have a low conductivity, and they have a poor compatibility with a resin which is to be a binder since they have a large number of pores and thus have a large surface area. However, since a slurry composition of the present invention may contain a surfactant as mentioned below, even LiFePO₄ or LiCoPO₄ may also be suitably used.

In a slurry composition of the present invention, as an active material for an electrode, those having an average particle size of not smaller than 0.01 μm and smaller than 50 μm can be suitably used, and more suitably, those having an average particle size of 0.1 μm to 30 μm can be used. When the particle size is within the above-mentioned range, the amount of a polymer binder resin to be added can be made small, decrease in the battery capacity can be inhibited, as well as, precipitation of the active material for an electrode can be prevented, and the dispersibility of the slurry composition can be made favorable, thereby obtaining a uniform electrode. Herein, the term “particle size” refers to the maximum distance L of distances between arbitrary two points on the profile line of the particle; and the term “average particle size” refers to a value which is calculated as an average value of the particle size of particles which are observed in several to several tens of fields of view by using an observation means such as a scanning electron microscope (SEM) or a transmission electron microscope (TEM).

When an iron-based oxide having a poor electro-conductivity is used as an active material for an electrode, the iron-based oxide can be used as an active material for an electrode which is covered with a carbon material by setting a carbon source material to exist during reduction firing. The carbon source materials may be those in which an element is partly replaced. An active material for an electrode for a non-aqueous electrolyte secondary battery may be a mixture of the above-mentioned inorganic compound and an organic compound which is a conductive polymer such as polyacetylene or poly-p-phenylene.

### <Polymer Binder Resin>

In the slurry composition of the present invention, the polymer binder resin is preferably a polymer binder resin (water-dispersible polymer binder resin) which can be dispersed in the below-mentioned aqueous solvent. Examples of the polymer binder resin include a non-fluorine polymer such as vinyl polymer, acrylic polymer, nitrile polymer, polyurethane polymer, diene polymer and a fluorine polymer such as PVDF or PTFE. In particular, from the viewpoint of adhesive properties between a current collector and a slurry composition, a non-fluorine polymer is preferred and an acrylic resin is more preferred.

When an acrylic resin is used as a polymer binder resin, those composed of a copolymer of an acrylic acid ester or methacrylic acid ester and another functional monomer may be used. The above-mentioned acrylic resin is not particularly restricted, and a known acrylic resin may be used. Further, the acrylic acid ester, methacrylic acid ester and other monomer which are used for synthesizing the above-mentioned acrylic resin are also not particularly restricted, and known ones can be used. In a slurry composition of the present invention, the acrylic resin may be used in a state of aqueous emulsion or an aqueous dispersion.

As a method of preparing an aqueous emulsion, a known method can be employed. An aqueous emulsion is manufactured by emulsion polymerization such as a surfactant method in which a surfactant such as a soap is used or a colloidal method in which a water soluble polymer such as a polyvinyl alcohol is used as a protective colloid, and a batch polymerization method, a pre-emulsion dropping method, a monomer dropping method, or the like may be used. By controlling the monomer concentration, reaction temperature, stirring speed, or the like, the average particle size of each polymer in an aqueous emulsion can be changed. The particle size distribution of a polymer can be made sharp by emulsion polymerization; by using such an aqueous emulsion, each component in an electrode can be made homogenous.

As the aqueous dispersion, a polytetrafluoroethylene aqueous dispersion can be suitably used. Also for a method of preparing an aqueous dispersion, a known method can be employed, and the polytetrafluoroethylene aqueous dispersion can be obtained by dispersing polytetrafluoroethylene in water.

Examples of the acrylic acid ester and methacrylic acid ester which are used for synthesizing an acrylic resin relating to a slurry composition of the present invention include methyl acrylate, methyl methacrylate, ethyl acrylate, ethyl methacrylate, n-propyl acrylate, n-propyl methacrylate, n-butyl acrylate, n-butyl methacrylate, t-butyl acrylate, t-butyl methacrylate, n-hexyl acrylate, n-hexyl methacrylate, 2-ethyl hexyl acrylate, 2-ethyl hexyl methacrylate, cyclohexyl acrylate, cyclohexyl methacrylate, stearyl acrylate, stearyl methacrylate, octadecyl acrylate, octadecyl methacrylate, phenyl acrylate, phenyl methacrylate, benzyl acrylate, benzyl methacrylate, chloromethyl acrylate, chloromethyl methacrylate, 2-chloroethyl acrylate, 2-chloroethyl methacrylate, 2-hydroxyethyl acrylate, 2-hydroxyethyl methacrylate, 3-hydroxypropyl acrylate, 3-hydroxypropyl methacrylate, 2,3,4,5,6-pentahydroxyhexyl acrylate, 2,3,4,5,6-pentahydroxyhexyl methacrylate, 2,3,4,5-tetrahydroxypentyl acrylate, 2,3,4,5-tetrahydroxypentyl methacrylate, aminoethyl acrylate, propyl aminoethyl acrylic acid, dimethyl aminoethyl methacrylic acid, ethyl aminopropyl methacrylic acid, phenyl aminoethyl methacrylic acid, and cyclohexyl aminoethyl methacrylic acid. These may be used singly or two or more of these may be used.

In an acrylic resin related to a slurry composition of the present invention, a functional monomer can be added other than the above-mentioned acrylic acid ester and the above-mentioned methacrylic acid ester. Examples of a monofunctional monomer include: an aromatic vinyl monomer such as styrene, α-methylstyrene, 1-vinyl naphthalene, 3-methylstyrene, 4-propyl styrene, 4-cyclohexylstyrene, 4-dodecylstyrene, 2-ethyl-4-benzylstyrene, 4-(phenyl butyl)styrene, or halogenated styrene; a vinyl cyanide monomer such as acrylonitrile or methacrylonitrile; and a conjugated diene monomer such as butadiene, isoprene, 2,3-dimethylbutadiene, 2-methyl-3-ethylbutadiene, 1,3-pentadiene, 3-methyl-1,3-pentadiene, 2-ethyl-1,3-pentadiene, 1,3-hexadiene, 2-methyl-1,3-hexadiene, 3,4-dimethyl-1,3-hexadiene, 1,3-heptadiene, 3-methyl-1,3-heptadiene, 1,3-octadiene, cyclopentadiene, chloroprene, or myrcene. Examples of the polyfunctional monomer include allyl methacrylate, allyl acrylate, triallyl cyanurate, triallyl isocyanurate, diallyl phthalate, diallyl malate, divinyl adipate, divinyl benzene ethylene glycol dimethacrylate, divinyl benzene ethylene glycol diacrylate, diethylene glycol dimethacrylate, diethylene glycol diacrylate, triethylene glycol dimethacrylate, triethylene glycol diacrylate, trimethylolpropane trimethacrylate, trimethylolpropane triacrylate, tetramethylolmethane tetramethacrylate, tetramethylolmethane tetraacrylate, dipropylene glycol dimethacrylate and dipropylene glycol diacrylate, and two or more of these may be used in combination.

The method of manufacturing an acrylic resin according to the present invention is not particularly restricted, and a known manufacturing method can be used.

In the slurry composition of the present invention, another polymer particle may be added to a polymer binder resin as needed. Examples of the polymer particle include a non-fluorine polymer such as vinyl polymer, acrylic polymer, nitrile polymer, polyurethane polymer, or diene polymer; and a fluorine polymer such as PVDF or PTFE. Particularly from the viewpoint of adhesive properties, non-fluorine polymer is preferred. In the slurry composition of the present invention, these polymer particle may be used singly, or two or more of these may be used by mixing them.

In the slurry composition of the present invention, the content ratio of a polymer binder resin (polymer particle) is preferably 0.1 to 10 parts by mass, and more preferably, 0.5 to 5 parts by mass in a solid content with respect to 100 parts by mass of an active material for an electrode. When the content ratio of the polymer particle is in the above-mentioned range, the adhesion of a slurry composition layer obtained by applying the slurry composition of the present invention to a current collector and drying to a current collecting plate and the flexibility thereof can be improved.

In the slurry composition of the present invention, the average particle size of a polymer binder resin is preferably 0.05 to 5 μm, and more preferably 0.1 to 1 μm. When the particle size is too large, the binding capacity may be deteriorated; when the particle size is too small, the surface of an active material for an electrode is covered with the particles, and the internal resistance may be increased.

### <Acid>

The slurry composition of the present invention contains an acid. Although the cause of decrease in the viscosity of a slurry composition is not necessarily clear, the present inventor assumes that the viscosity decreases because, when the slurry composition is prepared, the slurry becomes alkali due to the addition of an active material to a slurry containing water as a solvent, whereby a polymer binder resin or other components contained in the slurry are subjected to an action such as hydrolysis. In fact, by adding an acid to a slurry composition, the pH of the slurry composition can be adjusted, thereby inhibiting decrease in the viscosity.

Examples of the acid include inorganic acids such as nitric acid, sulfuric acid, hydrochloric acid, boric acid, inorganic phosphoric acid, and hydrofluoric acid; and organic acids such as polyacrylic acid, formic acid, acetic acid, acetoacetic acid, citric acid, stearic acid, maleic acid, fumaric acid, phthalic acid, benzene sulfonic acid, sulfamic acid, and organic phosphoric acid.

Among these, inorganic acids are preferred. Organic acids may have an influence on the polymer binder resin, thickener, surfactant, and other slurry components, and may have an influence on the characteristics of a slurry composition, and in turn, a slurry composition layer which is formed by applying the slurry composition to a current collector. For example, since polyacrylic acid increases the viscosity of a slurry composition, adjustment for appropriately applying a slurry composition containing polyacrylic acid to a current collector is difficult. On the other hand, inorganic acids do not have an influence on a polymer binder resin and other slurry components, and therefore the pH of the slurry composition can be adjusted. Concretely, the inorganic acid is hexafluorophosphate. By using hexafluorophosphate, the pH can be effectively adjusted.

The amount of the acid to be added is preferably 0.001 to 10 parts by mass, more preferably 0.01 to 1 parts by mass, and further preferably 0.01 to 0.1 parts by mass with respect to 100 parts by mass of an active material for an electrode. When the amount is in a range of 0.001 parts by mass to 10 parts by mass, a more excellent viscosity stability can be obtained.

The pH of a slurry composition of the present invention containing an acid is preferably in a range of 2.0 to 9.0, more preferably in a range of 5.0 to 8.0. When the pH is in a range of 2.0 to 9.0, more excellent viscosity stability can be obtained. The pH measurement method is performed in accordance with JIS Z8802 8.

### <Conductive Assistant>

A slurry composition of the present invention may contain a conductive assistant. For the conductive assistant, a conductive carbon such as acetylene black, Ketjen black, carbon black, graphite, vapor growth carbon fiber, carbon nanotube, graphene, or fullerene can be used. By using a conductive assistant, electrical contact between active materials for an electrode can be improved. When a conductive assistant is used for a non-aqueous electrolyte secondary battery, discharge rate characteristics can be improved. The amount of a conductive assistant to be added is preferably 0.1 to 20 parts by mass, and more preferably 0.1 to 10 parts by mass with respect to 100 parts by mass of an active material for an electrode.

### <Surfactant>

A slurry composition of the present invention may contain a surfactant. The surfactant is not particularly restricted as long as the surfactant has a high dispersibility into the electrolyte, has a low reactivity with lithium ion or the like, and does not prevent ion conduction in the electrolyte. Examples of the surfactant include a cationic surfactant, an anionic surfactant, an amphoteric surfactant, and a nonionic surfactant. A nonionic surfactant is particularly preferably used since it has low reactivity with surrounding ions (lithium ion or the like) and does not prevent ion conduction in an electrolyte and on the surface of an active material. In the slurry composition of the present invention, a surfactant may be used singly, or two or more thereof may be used by mixing.

Examples of the cationic surfactant include mono-long-chain alkyl type quaternary ammonium salt, di-long-chain alkyl type quaternary ammonium salt, and alkylamine salt. Examples of the anionic surfactant include alkylbenzene sulfonate, alkyl sulfate, alkyl ether sulfate, alkenyl ether sulfate, alkenyl sulfate, α-olefin sulfonate, α-sulfo-fatty acid or ester salts thereof, alkanesulfonate, saturated fatty acid, unsaturated fatty acid, alkyl ether carboxylate, alkenyl ether carboxylate, amino acid surfactant, N-acyl amino acid surfactant, alkyl phosphoric acid ester or salts thereof, alkenyl phosphoric acid ester or salts thereof, and alkyl sulfosuccinate. Examples of the amphoteric surfactant include a carboxyl amphoteric surfactant and a sulfobetaine amphoteric surfactant.

Examples of the nonionic surfactant which can be suitably used include polyoxyethylene alkyl ether such as polyoxyethylene lauryl ether, polyoxyethylene acetyl ether, polyoxyethylene stearyl ether, polyoxyethylene oleyl ether, polyoxyethylene higher alkyl ether; polyoxyethylene alkyl aryl ether such as polyoxyethylene nonylphenyl ether; polyoxyethylene sorbitan fatty acid ester such as polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate; sucrose fatty acid ester; polyoxyethylene sorbitol fatty acid ester such as tetraoleic acid polyoxyethylene sorbitol; polyoxyethylene fatty acid ester such as polyethylene glycol monolaurate, polyethylene glycol monostearate, polyethylene glycol distearate, or polyethylene glycol monooleate; polyoxyethylene alkylamine; polyoxyethylene hydrogenated castor oil; a block copolymer of ethylene oxide and propylene oxide; sorbitan fatty acid ester such as sorbitan monolaurate, sorbitan monomyristylate, sorbitan monopalmitate, sorbitan monostearate, sorbitan tristearate, sorbitan monooleate, sorbitan trioleate, sorbitan sesquioleate, sorbitan distearate; glycerin fatty acid ester such as glycerol monostearate, glycerol monooleate, diglycerol monooleate, or self-emulsifying glycerol monostearate; and alkyl alkanol amide.

In the slurry composition of the present invention, when a nonionic surfactant is used as a surfactant, the nonionic surfactant is preferably a polymer material, and the weight average molecular weight of the nonionic surfactant is preferably 500 or higher. When the weight average molecular weight of the nonionic surfactant is 500 or higher, a dispersion effect of an active material for an electrode due to the surfactant is favorably exercised. This is thought to be because the affinity between the solvent and the surfactant becomes high due to the polymer surfactant and solvent near particles is easy to be retained, thereby inhibiting precipitation between the particles. On the other hand, the upper limit of the weight average molecular weight is not particularly restricted, and the weight average molecular weight is preferably 100,000 or smaller. The weight average molecular weight of the nonionic surfactant in the slurry composition of the present invention is more suitably from 1,000 to 50,000. When the weight average molecular weight is in this range, the dispersibility of an active material for an electrode is more favorable and ion moves smoothly.

Among the nonionic surfactants, a polyethylene glycol surfactant which has a high ion conductivity and can be used for an electrolyte of a lithium ion battery is preferred, a polyethylene glycol fatty acid ester surfactant is more preferred, and stearic acid esters of polyethylene glycol are further preferred. The stearic acid esters of polyethylene glycol have a high thickening effect and have an excellent effect of preventing flocculation precipitation of an active material. By using a polyethylene glycol surfactant for covering an active material, movement of lithium ion in the surfactant can be accelerated. In the present invention, the term “polyethylene glycol surfactant” refers to a surfactant compound including an ethylene glycol chain.

The HLB of a surfactant used for the slurry composition of the present invention in accordance with a Griffin method is preferably from 13 to 20, and more preferably from 15 to 20. In particular, when an organic solvent is not used for the solvent, the HLB is more preferably from 16 to 20. When a surfactant having an HLB in this range is used, hydrophilic groups and hydrophobic groups of the surfactant are aligned in a good balance, and therefore uniform dispersion of an active material for an electrode having polarity in water solvent and a polymer binder resin is accelerated. Based on the formula weight and molecular weight of hydrophilic groups of the surfactant, the Griffin method is defined by the following formula:

HLB value=20×total sum of formula weight of hydrophilic portion/molecular weight.

In the slurry composition of the present invention, the amount of a surfactant to be added is preferably 0.1 to 10 parts by mass, and more preferably 0.5 to 5 parts by mass with respect to 100 parts by mass of an active material for an electrode. When the amount of a surfactant to be added is in the above-mentioned range, a slurry composition having an excellent dispersibility of an active material for an electrode in the slurry composition and excellent coating properties can be obtained.

### <Thickener>

The slurry composition of the present invention may contain a thickener. The thickener is not particularly restricted as long as it is a material which is stable against a solvent or an electrolyte which is used when an electrode is manufactured or other materials which are used when a battery is used. Examples thereof which can be used include carboxylmethyl cellulose, methyl cellulose, hydroxymethyl cellulose, ethyl cellulose, polyvinyl alcohol, oxidized starch, phosphorylated starch, and casein. These may be used singly or two or more of these may be used by mixing. The amount of a thickener to be added is usually from 0.01 to 20 parts by mass and preferably from 1 to 10 parts by mass with respect to 100 parts by mass of an active material for an electrode. When the amount of a thickener to be added is in the above-mentioned range, flocculation precipitation of an active material for an electrode with a high specific gravity can be favorably prevented.

### <Solvent>

A solvent which is used for a slurry composition of the present invention is not particularly restricted as long as it uniformly disperses a polymer binder resin and an active material for an electrode and it has an affinity with a surfactant which prevents flocculation precipitation, and the solvent may be water or an organic solvent. In the slurry composition of the present invention, the solvent may include both a solvent for the whole slurry composition and a solvent for an acid. Since water is used for a solvent of an acid, water is particularly suitably used also for a solvent for the whole slurry composition; however, the solvent for the whole slurry composition may contain an organic solvent as long as the above-mentioned effect is not inhibited. Examples of such an organic solvent include alicyclic hydrocarbons such as cyclopentane, and cyclohexane; aromatic hydrocarbons such as toluene, xylene, and ethylbenzene; ketones such as acetone, ethyl methyl ketone, diisopropyl ketone, cyclohexanone, methylcyclohexane, and ethylcyclohexane; chlorine-containing aliphatic hydrocarbons such as methylene chloride, chloroform, and carbon tetrachloride; esters such as ethyl acetate and butyl acetate, γ-butyrolactone, ε-caprolactone; acylnitriles such as acetonitrile and propionitrile; ethers such as tetrahydrofuran and ethylene glycol diethylether; alcohols such as methanol, ethanol, isopropanol, ethylene glycol, and ethylene glycol monomethylether; and amides such as N-methylpyrrolidone and N,N-dimethyl formamide.

### <Other Additives>

The slurry composition of the present invention contains the above-mentioned active material for an electrode, polymer binder resin, and acid, and may also contain other components as additives as long as they do not have an influence on a battery reaction. For example, the slurry composition of the present invention may contain, other than the above-mentioned components, a reinforcing member, thickener, antifoaming•leveling agent, electrolyte decomposition inhibitor, or the like.

As the reinforcing member, various inorganic and organic filler having a spherical shape, a plate shape, a rod shape, or fibrous shape may be used. By using a reinforcing member, an electrode which is further strong and flexible can be obtained, and excellent long-term cycle characteristics can be provided. These may be used singly or two or more of these may be used by mixing. The amount of the reinforcing member to be added is usually from 0.01 to 20 parts by mass, and preferably from 1 to 10 parts by mass with respect to 100 parts by mass of an active material for an electrode. When the amount of the reinforcing member to be added is in the above-mentioned range, high capacity and high load characteristics can be provided.

For the antifoaming•leveling agent, a surfactant such as alkyl surfactant, silicone surfactant, fluorinated surfactant, or metal surfactant can be used. When a surfactant is mixed in, repelling which occurs during coating can be prevented, and the smoothness of an electrode can be improved. The amount of the antifoaming•leveling agent to be added is preferably 0.01 to 5 parts by mass with respect to 100 parts by mass of an active material for an electrode. When the amount of the antifoaming•leveling agent to be added is in the above-mentioned range, a coating failure during coating of an electrode can be prevented, thereby improving productivity.

For the electrolyte decomposition inhibitor, vinylene carbonate or the like which is used in an electrolyte can be used. The amount of the electrolyte decomposition inhibitor in an electrode to be added is preferably from 0.01 to 5 parts by mass with respect to 100 parts by mass of an active material for an electrode. When the amount of the electrolyte decomposition inhibitor in an electrode to be added is in the above-mentioned range, the cycle characteristics and high temperature characteristics can be further improved. Examples of the electrolyte decomposition inhibitor other than the above include nanoparticle such as fumed silica or fumed alumina. When nanoparticle is mixed in, the thixotropy of a mixture for forming an electrode can be controlled. The amount of nanoparticle in a slurry composition of the present invention to be added is preferably from 0.01 to 5 parts by mass with respect to 100 parts by mass of an active material for an electrode. When the amount of nanoparticle in a slurry composition to be added is in the above-mentioned range, the stability of a mixture and productivity can be further improved, and a more excellent battery characteristics can be provided.

### <Method of Manufacturing Slurry Composition>

The slurry composition of the present invention can be obtained by mixing the above-mentioned active material for an electrode, polymer binder resin, acid, and preferably a conductive assistant, surfactant, and other additives as needed. An acid is preferably added to a slurry as an aqueous solution. When a slurry composition of the present invention is manufactured, it is preferred that an active material and an acid are mixed and then a polymer binder resin is added thereto and further mixed to manufacture a slurry composition. By mixing an active material and an acid in advance, the acid can be dispersed in the slurry to neutralize the slurry, and as the result, a more excellent viscosity stability can be obtained. A method of mixing is not particularly restricted, and for example, a method in which a mixing device of stirring type, shaking type, rotary type, or the like is used can be adopted. A method in which a dispersing and kneading apparatus such as a homogenizer, ball mill, sand mill, roll mill, or planetary kneading machine is used may be adopted.

### <Electrode>

Next, an electrode for a non-aqueous electrolyte secondary battery of the present invention will be described.

The electrode of the present invention is formed by applying the above-mentioned slurry composition of the present invention to a current collector. The electrode of the present invention can be manufactured by performing a coating process in which the above-mentioned slurry composition of the present invention is applied onto a current collector, and a drying process in which the obtained current collector is dried to form a slurry composition layer. In the electrode of the present invention, the slurry composition layer may be formed on one side of the current collector, and preferably, the slurry composition layers are formed on both sides of the current collector. The electrode is preferably a positive electrode from the viewpoint that deterioration of the viscosity after the preparation of the slurry composition can be considerably prevented. The constitution of the electrode of the present invention and a method of manufacturing the electrode of the present invention will be described in detail.

### <Current Collector>

The current collector which is used for the electrode of the present invention is not particularly restricted as long as it is a material which has electro-conductivity and electrochemically durable, and a metal material which has thermal resistance is preferred. Examples of the material for the current collector include iron, copper, aluminum, nickel, stainless steel, titanium, tantalum, gold, and platinum. In particular, aluminum or an aluminum alloy is preferred since deterioration caused by oxidation during charging is small. The shape of the current collector is not particularly restricted, and a sheet shape having a thickness of about 5 to 100 μm can be suitably used.

In the electrode of the present invention, the current collector is preferably subjected to a roughening treatment in advance before use in order to increase the adhesion strength with a slurry composition layer. Examples of the roughening treatment include a mechanical polishing method, electrolytic polishing method, and chemical polishing method. In the mechanical polishing method, coated abrasives on which abrasive particles are fixed, a grinding stone, an emery wheel, a wire brush provided with steel wires or the like, or the like can be used. In order to increase the adhesion strength or the electric conductivity of the electrode layer, an intermediate layer may be formed on the surface of the current collector.

### <Coating Method>

The method of applying the above-mentioned slurry composition of the present invention onto a current collector is not particularly restricted, and a known method can be used. Examples of the coating method include die coating, doctor coating, dip coating, roll coating, spray coating, gravure coating, screen printing, and electrostatic coating.

### <Drying Method>

A method of drying a current collector obtained by the above-mentioned coating method is not particularly restricted, and examples thereof include drying by a warm wind, a hot wind, or a low-humidity air, vacuum drying and a drying method using irradiation of a (far-) infrared ray or an electron ray or the like. Drying time is usually from 5 to 30 minutes, and drying temperature is usually from 40 to 180° C.

### <Rolling>

In the manufacturing method of the present invention, preferably, a coating process and a drying process are performed, and then, a rolling process in which the porosity of a slurry composition layer is reduced by a pressure treatment using mold press, roll press, or the like is performed. A suitable range of the porosity is from 5% to 15%, and more suitable 7% to 13%. When the porosity is above 15%, the charging efficiency or discharging efficiency is deteriorated, which is not preferred. On the other hand, when the porosity is less than 5%, a high volume capacity is hard to be obtained, or a slurry composition layer is likely to be peeled off from a current collector and a failure is likely to occur, which may be problematic. When a curable resin is used as a polymer binder resin, a process in which the curable resin is cured is preferably included.

The thickness of the electrode of the present invention is usually from 5 to 400 μm, and preferably 30 to 300 μm. When the thickness of the electrode is in the above-mentioned range, favorable flexibility and adhesion of an electrode plate can be obtained.

### <Non-Aqueous Electrolyte Secondary Battery>

Next, a non-aqueous electrolyte secondary battery of the present invention will be described.

The non-aqueous electrolyte secondary battery of the present invention uses the above-mentioned electrode of the present invention, and comprises a positive electrode, negative electrode, separator and electrolyte. In the following, the constitution of the non-aqueous electrolyte secondary battery of the present invention and a manufacturing method thereof will be described in detail.

### <Negative Electrode for Non-Aqueous Electrolyte Secondary Battery>

A negative electrode for a non-aqueous electrolyte secondary battery related to the present invention can be manufactured by mixing a negative electrode active material, conductive assistant, polymer binder resin, solvent and other additives or the like as needed to prepare a negative electrode mixture slurry, then applying the slurry to a current collector, drying, and, as needed, rolling.

As the negative electrode active material, a conventionally used, known material can be used as long as it is an active material which can occlude and release lithium ion, and any of carbon active material and non-carbon active material may be used. Examples of the carbon active material include graphite, soft carbon, and hard carbon. Examples of the non-carbon active material include a known one such as lithium metal, a lithium alloy, oxide, and sulfide, and a lithium-containing metal complex oxide.

For the conductive assistant and solvent, the above-mentioned conductive assistant and the above-mentioned solvent which are used for manufacturing an electrode of the present invention can be used. For the binder resin, those which are generally used for a non-aqueous electrolyte secondary battery such as SBR particle and PVDF resin can be used.

For a current collector which is used for a negative electrode for a non-aqueous electrolyte secondary battery related to the present invention, any material can be used without particular restrictions as long as it has electro-conductivity and is electrochemically durable in a similar manner to a positive electrode for a non-aqueous electrolyte secondary battery of the present invention, and a similar material to that of the above-mentioned current collector which is used for an electrode for a non-aqueous electrolyte secondary battery of the present invention can be used.

### <Electrolyte>

The electrolyte which is used in the present invention is not particularly restricted and, for example, those obtained by dissolving a lithium salt as a supporting electrolyte in a non-aqueous solvent can be used. Examples of the lithium salt include LiPF₆, LiAsF₆, LiBF₄, LiSbF₆, LiAlCl₄, LiClO₄, CF₃SO₃Li, C₄F₉SO₃Li, CF₃COOLi, (CF₃CO)₂NLi, (CF₃SO₂)₂NLi, and (C₂F₅SO₂)NLi. In particular, LiPF₆, LiClO₄, or CF₃SO₃Li which is likely to be dissolved in a solvent and exhibits a high degree of dissociation can be suitably used. These may be used singly or two or more of these may be used by mixing. The amount of the supporting electrolyte to be added is usually 1% by mass or larger, and preferably 5% by mass or larger, and usually 30% by mass or smaller, and preferably 20% by mass or smaller with respect to electrolyte. When the amount of the supporting electrolyte is either too small or too large, the ion conductivity is decreased, and therefore charging characteristics and discharging characteristics of a battery are deteriorated.

The solvent used for an electrolyte is not particularly restricted as long as it dissolves a supporting electrolyte, and examples there of which can be used include alkyl carbonates such as dimethyl carbonate (DMC), ethylene carbonate (EC), diethyl carbonate (DEC), propylene carbonate (PC), butylene carbonate (BC), and methyl ethyl carbonate (MEC); esters such as γ-butyrolactone and methyl formate; ethers such as 1,2-dimethoxyethane, and tetrahydrofuran; and sulphur-containing compounds such as sulfolan and dimethyl sulfoxide. In particular, dimethyl carbonate, ethylene carbonate, propylene carbonate, diethyl carbonate, and methyl ethyl carbonate are preferred since a high ion conductivity is likely to be obtained and the temperature range in which they can be used is wide. These solvents may be used singly, or two or more of these may be used by mixing.

To the electrolyte, other additives may be added. Examples of the additives include a carbonate compound such as vinylene carbonate (VC), cyclohexylbenzene and diphenyl ether.

When an electrolyte other than the above is used for a non-aqueous electrolyte secondary battery of the present invention, for example, a gel polymer electrolyte obtained by impregnating an electrolyte with a polymer electrolyte such as polyethylene oxide or polyacrylonitrile, or an inorganic solid electrolyte such as Lithium sulfide, LiI, or Li₃N can be used.

### <Separator>

A separator is a porous substrate with pores, and (a) a porous separator with pores, (b) a porous separator on one side or both sides of which a polymer coating layer is formed, or (c) a porous separator on which an inorganic ceramic powder-containing porous resin coating layer can be used. Examples of the separator include a polypropylene-based, polyethylene-based, polyolefin-based, or aramid-based porous separator; a polymer film for a solid polymer electrolyte such as polyvinylidene fluoride, polyethylene oxide, polyacrylonitrile, or polyvinylidene fluoride hexafluoropropylene copolymer or for a gel polymer electrolyte; a separator coated with a gelled polymer coating layer; or a separator coated with a porous film layer composed of an inorganic filler or a dispersant for the inorganic filler.

### <Method of Manufacturing Non-Aqueous Electrolyte Secondary Battery>

A method of manufacturing a non-aqueous electrolyte secondary battery of the present invention is not particularly restricted. For example, a negative electrode and a positive electrode are overlapped with each other via a separator and they are rolled, folded, or the like, in accordance with the shape of a battery to be inserted into a battery container, and then an electrolyte is poured into the battery container to be sealed. Into the non-aqueous electrolyte secondary battery of the present invention, an overcurrent preventing element such as an expand metal, fuse, or PTC element, lead plate, or the like can be contained as needed to thereby also prevent pressure rise, or over-charge or over-discharge inside the battery. The shape of the battery may be any of laminated cell-type, coin-type, button-type, sheet-type, cylinder-type, square-type, oblate-type, or the like.

### EXAMPLES

The present invention will be described in detail with reference to Examples.

### Examples 1 to 11, Comparative Examples 1 to 3

As Examples 1 to 11 and Comparative Examples 1 to 3, an active material for electrodes, polymer binder resin, thickener•surfactant, conductive assistant, and acid as listed on Tables 1 to 4 were prepared in solid content ratios listed on the Tables. Next, to a mixture of an electrode active material and a conductive assistant, an acid was added and further mixed. To the mixture, a thickener•surfactant and a water-dispersible polymer binder resin were added, and the mixture was stirred for 10 minutes with a stirrer, then ion exchanged water was added thereto to manufacture a slurry whose viscosity was adjusted.

The obtained slurry was stored in a closed container at room temperature, and the viscosity was measured by using a rotary viscometer for each time listed on the Tables. The pH of the slurry was also measured. The measurement of pH was performed in accordance with JIS Z8802. From the measured viscosity, a rate of change of the slurry viscosity per each elapsed time was calculated.

Thereafter, each slurry was applied to one side of an aluminum foil having a thickness of 20 μm by using an applicator of 50 μm. Then, the foil was dried in a hot air circulation boxy drying furnace at 150° C. for 20 minutes to remove water which was a solvent. The foil was cooled to room temperature, then sandwiched by stainless plates of 1 mm and rolling was performed at a pressure of 1.5 ton/cm² at normal temperature for one minute by using a plate pressing machine to manufacture an electrode plate having active material mixture layer having 80 μm on one side. The adhesion of the slurry composition layer after drying the slurry composition was evaluated in process through manufacturing the slurry composition to manufacturing the electrode plate. Detailed method of the evaluation is described below. Obtained results are listed in the Tables below in combination.

<Adhesion of Slurry Composition Layer after Drying>

After applying and drying the slurry composition onto a current collector, in accordance with JIS K-5600, the applied surface was carried out cross cut test under the condition of 2 mm cutting gap and 25 squares grid pattern. Obtained result was evaluated as followed; considerable dropout of intersection as “x”, few dropout of intersection as “Δ”, no dropout of intersection as “∘”.

TABLE 1

| | | Example 1 | Example 2 | Example 3 | Example 4 |
|---|---|---|---|---|---|
| Positive electrode active | | Lithium | Lithium | Lithium | Lithium |
| material | | nickelate | cobartate | nickelate | nickelate |
| Solid content ratio (%) | | 90 | 90 | 90 | 90 |
| Water-dispersible polymer | | Styrene-acrylic | Styrene-acrylic | Styrene-acrylic | Acrylic |
| binder resin | | acid ester | acid ester | acid ester | resin |
| Solid content ratio (%) | | copolymer | copolymer | copolymer | 3.5 |
| | | 3.5 | 3.5 | 3.5 | |
| Thickener · surfactant | | EMANON | EMANON | EMANON | EMANON |
| Solid content ratio (%) | | 3299RV | 3299RV | 3299RV | 3299RV |
| | | 3.5 | 3.5 | 3.5 | 3.5 |
| Conductive assistant | | VGCF-H | VGCF-H | VGCF-H | VGCF-H |
| Solid content ratio (%) | | 3 | 3 | 3 | 3 |
| Acid | | Acetic acid | HPF₆ | HPF₆ | HPF₆ |
| Solid content ratio (%) | | 0.04 | 0.01 | 0.03 | 0.03 |
| pH of slurry | | 6 to 8 | 6 to 8 | 6 to 8 | 6 to 8 |
| Slurry | Initial | 206.3 | 217.1 | 207.4 | 264.2 |
| viscosity | 1 hour later | 196.0 | 211.6 | 200.8 | 250.6 |
| (Ps) | (normal temperature) | | | | |
| | 6 hours later | 197.5 | 217.3 | 207.0 | 258.3 |
| | (normal temperature) | | | | |
| | 12 hours later | 197.8 | 206.2 | 211.2 | 259.0 |
| | (normal temperature) | | | | |
| | 1 day later | 189.5 | 212.3 | 208.3 | 263.7 |
| | (normal temperature) | | | | |
| | 7 days later | 183.6 | 212.4 | 202.4 | 259.8 |
| | (normal temperature) | | | | |
| | 30 days later | 177.5 | 207.4 | 201.4 | 262.5 |
| | (normal temperature) | | | | |
| Slurry | 1 hour later | −5.0 | −2.5 | −3.2 | −5.1 |
| viscosity | (normal temperature) | | | | |
| rate of | 6 hours later | −4.3 | 0.1 | −0.2 | −2.2 |
| change | (normal temperature) | | | | |
| (%) | 12 hours later | −4.1 | −5.0 | 1.8 | −2.0 |
| | (normal temperature) | | | | |
| | 1 day later | −8.1 | −2.2 | 0.4 | −0.2 |
| | (normal temperature) | | | | |
| | 7 days later | −11.0 | −2.2 | −2.4 | −1.7 |
| | (normal temperature) | | | | |
| | 30 days later | −14.0 | −4.5 | −2.9 | −0.6 |
| | (normal temperature) | | | | |
| Adhesion | Initial | ∘ | ∘ | ∘ | ∘ |
| of slurry | 1 hour later | ∘ | ∘ | ∘ | ∘ |
| composition | (normal temperature) | | | | |
| layer | 6 hours later | ∘ | ∘ | ∘ | ∘ |
| | (normal temperature) | | | | |
| | 12 hours later | ∘ | ∘ | ∘ | ∘ |
| | (normal temperature) | | | | |
| | 1 day later | ∘ | ∘ | ∘ | ∘ |
| | (normal temperature) | | | | |
| | 7 days later | Δ | ∘ | ∘ | ∘ |
| | (normal temperature) | | | | |
| | 30 days later | Δ | ∘ | ∘ | ∘ |
| | (normal temperature) | | | | |

TABLE 21

| | | Example 5 | Example 6 | Example 7 | Example 8 |
|---|---|---|---|---|---|
| Positive electrode active | | Lithium | Lithium iron | Lithium | Lithium |
| material | | nickelate | phosphate | nickelate | nickelate |
| Solid content ratio (%) | | 90 | 90 | 90 | 90 |
| Water-dispersible polymer | | Mowinyl | Styrene-acrylic | Styrene-acrylic | Styrene-acrylic |
| binder resin | | LDM7523 | acid ester | acid ester | acid ester |
| Solid content ratio (%) | | 3.5 | copolymer | copolymer | copolymer |
| | | | 3.5 | 3.5 | 3.5 |
| Thickener · surfactant | | EMANON | EMANON | CMC | EMANON |
| Solid content ratio (%) | | 3299RV | 3299RV | 3.5 | 3299RV |
| | | 3.5 | 3.5 | | 3.5 |
| Conductive assistant | | VGCF-H | VGCF-H | VGCF-H | VGCF-H |
| Solid content ratio (%) | | 3 | 3 | 3 | 3 |
| Acid | | HPF₆ | HPF₆ | HPF₆ | H₂SO₄ |
| Solid content ratio (%) | | 0.03 | 0.02 | 0.03 | 0.02 |
| pH of slurry | | 6 to 8 | 6 to 8 | 6 to 8 | 6 to 8 |
| Slurry | Initial | 161.0 | 145.8 | 207.4 | 209.8 |
| viscosity | 1 hour later | 160.8 | 140.6 | 200.8 | 192.8 |
| (Ps) | (normal temperature) | | | | |
| | 6 hours later | 156.7 | 150.0 | 207.0 | 196.9 |
| | (normal temperature) | | | | |
| | 12 hours later | 157.6 | 140.9 | 211.2 | 193.2 |
| | (normal temperature) | | | | |
| | 1 day later | 152.3 | 145.9 | 208.3 | 193.7 |
| | (normal temperature) | | | | |
| | 7 days later | 156.1 | 146.1 | 202.4 | 180.8 |
| | (normal temperature) | | | | |
| | 30 days later | 152.2 | 152.9 | 201.4 | 170.4 |
| | (normal temperature) | | | | |
| Slurry | 1 hour later | −0.1 | −3.6 | −3.2 | −8.1 |
| viscosity | (normal temperature) | | | | |
| rate of | 6 hours later | −2.7 | 2.9 | −0.2 | −6.1 |
| change | (normal temperature) | | | | |
| (%) | 12 hours later | −2.1 | −3.4 | 1.8 | −7.9 |
| | (normal temperature) | | | | |
| | 1 day later | −5.4 | 0.1 | 0.4 | −7.7 |
| | (normal temperature) | | | | |
| | 7 days later | −3.0 | 0.2 | −2.4 | −13.8 |
| | (normal temperature) | | | | |
| | 30 days later | −5.5 | 4.9 | −2.9 | −18.8 |
| | (normal temperature) | | | | |
| Adhesion | Initial | ∘ | ∘ | ∘ | ∘ |
| of slurry | 1 hour later | ∘ | ∘ | ∘ | ∘ |
| composition | (normal temperature) | | | | |
| layer | 6 hours later | ∘ | ∘ | ∘ | ∘ |
| | (normal temperature) | | | | |
| | 12 hours later | ∘ | ∘ | ∘ | ∘ |
| | (normal temperature) | | | | |
| | 1 day later | ∘ | ∘ | ∘ | ∘ |
| | (normal temperature) | | | | |
| | 7 days later | ∘ | ∘ | ∘ | Δ |
| | (normal temperature) | | | | |
| | 30 days later | ∘ | ∘ | ∘ | Δ |
| | (normal temperature) | | | | |

TABLE 3

| | | Example 9 | Example 10 | Example 11 |
|---|---|---|---|---|
| Positive electrode active | | Lithium | Lithium | Lithium |
| material | | nickelate | nickelate | titanate |
| Solid content ratio (%) | | 90 | 90 | 90 |
| Water-dispersible polymer | | Styrene-acrylic | Styrene-acrylic | Styrene-acrylic |
| binder resin | | acid ester | acid ester | acid ester |
| Solid content ratio (%) | | copolymer | copolymer | copolymer |
| | | 3.5 | 3.5 | 3.5 |
| Thickener · surfactant | | EMANON | EMANON | EMANON |
| Solid content ratio (%) | | 3299RV | 3299RV | 3299RV |
| | | 3.5 | 3.5 | 3.5 |
| Conductive assistant | | VGCF-H | VGCF-H | VGCF-H |
| Solid content ratio (%) | | 3 | 3 | 3 |
| Acid | | HCl | HNO₄ | HPF₆ |
| Solid content ratio (%) | | 0.03 | 0.03 | 0.04 |
| pH of slurry | | 6 to 8 | 6 to 8 | 7 |
| Slurry | Initial | 208.8 | 206.3 | 192.9 |
| viscosity | 1 hour later | 195.5 | 195.3 | 196.5 |
| (Ps) | (normal temperature) | | | |
| | 6 hours later | 190.6 | 192.6 | 192.0 |
| | (normal temperature) | | | |
| | 12 hours later | 206.2 | 193.2 | 189.6 |
| | (normal temperature) | | | |
| | 1 day later | 204.0 | 199.4 | 187.8 |
| | (normal temperature) | | | |
| | 7 days later | 192.0 | 195.2 | 186.0 |
| | (normal temperature) | | | |
| | 30 days later | 176.7 | 176.0 | 184.2 |
| | (normal temperature) | | | |
| Slurry | 1 hour later | −6.4 | −5.3 | 1.8 |
| viscosity | (normal temperature) | | | |
| rate of | 6 hours later | −8.7 | −6.6 | −0.4 |
| change | (normal temperature) | | | |
| (%) | 12 hours later | −1.2 | −6.3 | −1.7 |
| | (normal temperature) | | | |
| | 1 day later | −2.3 | −3.3 | −2.6 |
| | (normal temperature) | | | |
| | 7 days later | −8.0 | −5.4 | −3.6 |
| | (normal temperature) | | | |
| | 30 days later | −15.4 | −14.7 | −4.5 |
| | (normal temperature) | | | |
| Adhesion | Initial | ∘ | ∘ | ∘ |
| of slurry | 1 hour later | ∘ | ∘ | ∘ |
| composition | (normal temperature) | | | |
| layer | 6 hours later | ∘ | ∘ | ∘ |
| | (normal temperature) | | | |
| | 12 hours later | ∘ | ∘ | ∘ |
| | (normal temperature) | | | |
| | 1 day later | ∘ | ∘ | ∘ |
| | (normal temperature) | | | |
| | 7 days later | Δ | Δ | Δ |
| | (normal temperature) | | | |
| | 30 days later | Δ | Δ | Δ |
| | (normal temperature) | | | |

TABLE 4

| | | Comparative | Comparative | Comparative |
|---|---|---|---|---|
| | | Example 1 | Example 2 | Example 3 |
| Positive electrode active | | Lithium | Lithium | Lithium |
| material | | nickelate | nickelate | titanate |
| Solid content ratio (%) | | 90 | 90 | 90 |
| Water-dispersible polymer | | Styrene-acrylic | Styrene-acrylic | Styrene-acrylic |
| binder resin | | acid ester | acid ester | acid ester |
| Solid content ratio (%) | | copolymer | copolymer | copolymer |
| | | 3.5 | 3.5 | 3.6 |
| Thickener · surfactant | | EMANON | CMC | EMANON |
| Solid content ratio (%) | | 3299RV | 3.5 | 3299RV |
| | | 3.5 | | 3.6 |
| Conductive assistant | | VGCF-H | VGCF-H | VGCF-H |
| Solid content ratio (%) | | 3 | 3 | 4 |
| Acid | | None | None | None |
| Solid content ratio (%) | | | | |
| pH of slurry | | 10 to 12 | 10 to 12 | 12 |
| Slurry | Initial | 193.2 | 207.4 | 193.5 |
| viscosity | 1 hour later | 54.7 | 50.8 | 46.2 |
| (Ps) | (normal temperature) | | | |
| | 6 hours later | 5.0 | 12.1 | 8.3 |
| | (normal temperature) | | | |
| | 12 hours later | 1.1 | 1.1 | 1.0 |
| | (normal temperature) | | | |
| | 1 day later | 1.1 | 1.0 | 1.1 |
| | (normal temperature) | | | |
| | 7 days later | 1.0 | 1.1 | 1.0 |
| | (normal temperature) | | | |
| | 30 days later | 1.0 | 1.0 | 1.0 |
| | (normal | | | |
| | temperature) | | | |
| Slurry | 1 hour later | −71.7 | −75.5 | −76.1 |
| viscosity | (normal temperature) | | | |
| rate of | 6 hours later | −97.4 | −94.2 | −95.7 |
| change | (normal temperature) | | | |
| (%) | 12 hours later | −99.4 | −99.5 | −99.5 |
| | (normal temperature) | | | |
| | 1 day later | −99.4 | −99.5 | −99.5 |
| | (normal temperature) | | | |
| | 7 days later | −99.5 | −99.5 | −99.5 |
| | (normal temperature) | | | |
| | 30 days later | −99.5 | −99.5 | −99.5 |
| | (normal temperature) | | | |
| Adhesion | Initial | Δ | Δ | Δ |
| of slurry | 1 hour later | x | x | x |
| composition | (normal temperature) | | | |
| layer | 6 hours later | x | x | x |
| | (normal temperature) | | | |
| | 12 hours later | x | x | x |
| | (normal temperature) | | | |
| | 1 day later | x | x | x |
| | (normal temperature) | | | |
| | 7 days later | x | x | x |
| | (normal temperature) | | | |
| | 30 days later | x | x | x |
| | (normal temperature) | | | |

In Tables 1 to 4, Mowinyl LDM7523 is acrylic/silicon resin manufactured by The Nippon Synthetic Chemical Industry Co., Ltd. EMANON 3299RV is a polyethylene glycol distearate nonionic surfactant manufactured by Kao Corporation (HLB: 19.2, molecular weight: about 11200). CMC is a thickener manufactured by Daicel FineChem Ltd. VGCF-H is a conductive assistant (vapor-grown carbon fiber) manufactured by Showa Denko K.K.

From Tables 1 to 4, in the slurry compositions of Examples, even when the slurry was stored for a long term, or even after 30 days, decrease in the viscosity was little. The adhesion between the slurry composition layer and the current collector after drying was excellent. On the other hand, since slurry compositions of Comparative Example 1 and Comparative Example 2 did not contain an acid, the decrease in the viscosity after the manufacture of the slurry compositions was manufactured was considerable, and the adhesion of the slurry composition layer was poor.

1. A slurry composition which is used for manufacturing an electrode for an electrochemical cell containing a lithium ion,
comprising a polymer binder resin, an acid, and an active material.

2. The slurry composition according to claim 1, wherein the acid is an inorganic acid.

3. The slurry composition according to claim 2, wherein the inorganic acid is hexafluorophosphate.

4. The slurry composition according to claim 1, further comprising a conductive assistant.

5. The slurry composition according to claim 1, further comprising at least any one of a thickener and surfactant.

6. The slurry composition according to claim 1, further comprising a solvent.

7. The slurry composition according to claim 6, comprising water as the solvent.

8. The slurry composition according to claim 1 which is a slurry for an electrode for a lithium ion battery.

9. An electrode formed by applying the slurry composition according to claim 1 to a current collector.

10. An electrode for a non-aqueous electrolyte secondary battery which uses the electrode according to claim 9.

11. A method of manufacturing an electrode for non-aqueous electrolyte secondary battery in which an active material and an acid are mixed, then a polymer binder resin is added thereto, and the mixture is further mixed to prepare a slurry composition and the slurry composition is applied to a current collector.
